(19) United States
(12) Patent Application Publication
(10) Pub. No.: US 2026/0230722 A1
(43) Pub. Date: Aug. 6, 2026

(54) PHOTOELECTRIC CONVERSION APPARATUS AND EQUIPMENT

(71) Applicant: CANON KABUSHIKI KAISHA, Tokyo (JP)

(72) Inventors: SATOSHI KOIZUMI, Kanagawa (JP); JUMPEI ASHIDA, Cupertino, CA (US)

(21) Appl. No.: 19/634,341

(22) Filed: Mar. 31, 2026

Related U.S. Application Data
(63) Continuation of application No. PCT/JP2024/035008, filed on Sep. 30, 2024.

(30) Foreign Application Priority Data
Oct. 25, 2023 (JP) 2023-183530

(51) Int. Cl. H04N 25/47; H04N 25/13; H04N 25/707; H04N 25/709

(52) U.S. Cl. CPC H04N 25/47; H04N 25/134; H04N 25/707; H04N 25/709

(57) ABSTRACT

A photoelectric conversion apparatus in which a plurality of pixel blocks, each pixel block includes a plurality of first pixels, a plurality of event detection pixels, a determination unit configured to perform event detection, and an interface unit configured to output signals from the plurality of first pixels in accordance with the event detection are arranged. Each of the plurality of event detection pixels includes a first event detection unit configured to output a signal in accordance with incident light, and a first counter unit configured to count signals output from the first event detection unit per a first unit time. The determination unit performs the event detection based on a sum of outputs from the first counter units of the plurality of event detection pixels.

### CROSS-REFERENCE TO RELATED APPLICATIONS

This application is a Continuation of International Patent Application No. PCT/JP/2024/035008, filed September 30, 2024, which claims the benefit of Japanese Patent Application No. 2023- 183530, filed October 25, 2023, both of which are hereby incorporated by reference herein in their entirety.

### BACKGROUND

### Field of the Technology

The present disclosure relates to a photoelectric conversion apparatus and equipment.

### Description of the Related Art

Japanese Patent Laid Open No. 2020- 096347 describes an image capturing apparatus that detects whether a predetermined address event has occurred based on whether the change amount of the incident light amount exceeds a predetermined threshold and, if an address event has occurred, counts the number of incident photons and outputs a pixel signal indicating the count value.

### SUMMARY

A photoelectric conversion apparatus according to an aspect of the present disclosure is a photoelectric conversion apparatus in which a plurality of pixel blocks are arranged, each pixel block including a plurality of first pixels, a plurality of event detection pixels, a determination unit configured to perform event detection, and an interface unit configured to output signals from the plurality of first pixels in accordance with the event detection, wherein each of the plurality of event detection pixels includes a first event detection unit configured to output a signal in accordance with incident light, and a first counter unit configured to count signals output from the first event detection unit per a first unit time, and the determination unit performs the event detection based on a sum of outputs from the first counter units of the plurality of event detection pixels.

Features of the present disclosure will become apparent from the following description of embodiments with reference to the attached drawings.

### BRIEF DESCRIPTION OF THE DRAWINGS

FIG. 1 is a view showing the schematic configuration of a photoelectric conversion apparatus according to an embodiment.

FIG. 2A is a schematic view showing an arrangement example of pixels in a pixel block according to the embodiment.

FIG. 2B is a schematic view showing an arrangement example of pixels in the pixel block according to the embodiment.

FIG. 2C is a schematic view showing an arrangement example of pixels in the pixel block according to the embodiment.

FIG. 2D is a schematic view showing an arrangement example of pixels in the pixel block according to the embodiment.

FIG. 3 is a circuit diagram showing an example of the configuration of the pixel according to the embodiment.

FIG. 4 is a functional block diagram showing an example of the configuration of the pixel block according to the embodiment.

FIG. 5 is a view showing a modification of an event detection operation according to the embodiment.

FIG. 6 is a schematic view showing an example of the configuration of the photoelectric conversion apparatus according to the embodiment.

FIG. 7 is a view showing the control of an event detection unit.

FIG. 8 is a view showing an application example of the photoelectric conversion apparatus according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the embodiments of the present disclosure described below, as an example of a photoelectric conversion apparatus, an image capturing apparatus capable of event detection will mainly be described. However, the photoelectric conversion apparatus in each embodiment is not limited to the image capturing apparatus, and is also applicable to another light detection apparatus based on photoelectric conversion. Examples of the other light detection apparatus are a distance measurement apparatus and a focus detection apparatus.

### Embodiment

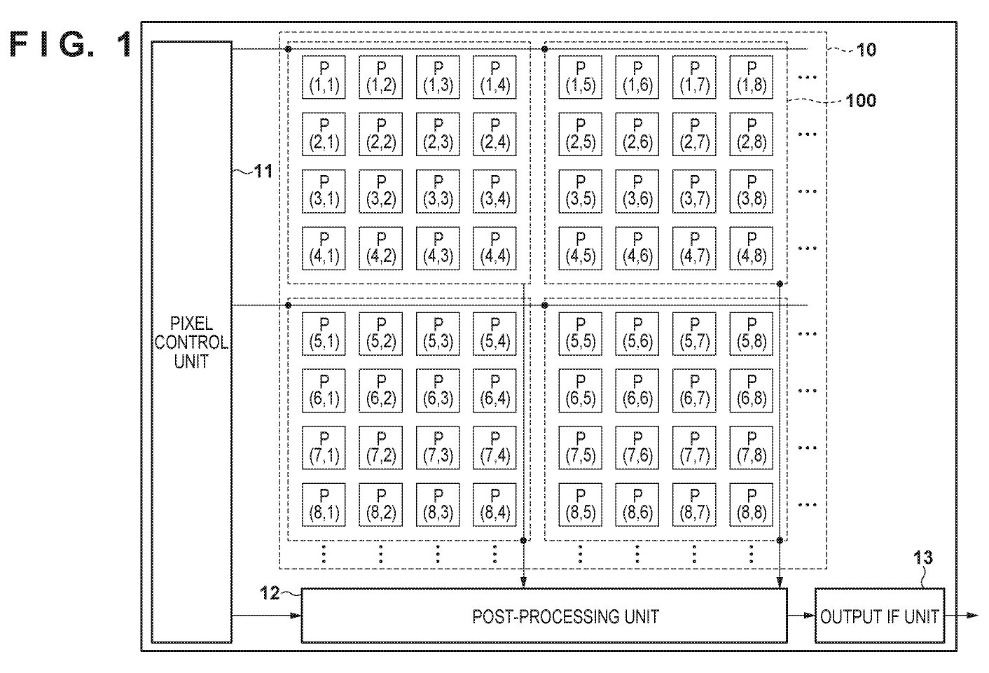

The schematic configuration of a photoelectric conversion apparatus 1 according to an embodiment of the present disclosure will be described with reference to FIG. 1. The photoelectric conversion apparatus 1 includes a pixel array 10, a pixel control unit 11, a post-processing unit 12, and an output interface (IF) unit 13. In the pixel array 10, a plurality of pixel blocks 100 are arranged so as to form a plurality of rows and a plurality of columns. As will be described later, a plurality of pixels are arranged in the pixel block 100. The pixel control unit 11 can perform control for driving the pixel array 10 to read out signals from the pixels. The post-processing unit 12 can perform correction processing or reordering processing on the image capturing signals read out from the pixels. The output interface unit 13 can output the image capturing signal and an event detection signal to the outside of the pixel array 10.

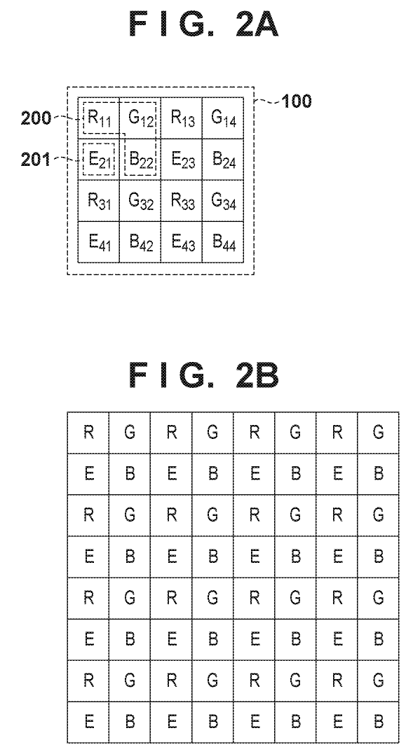

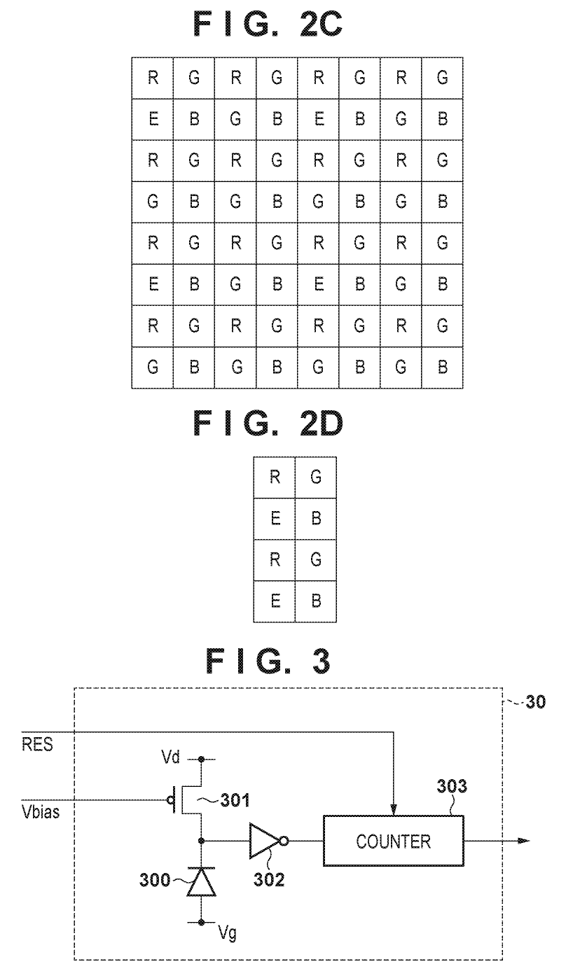

Arrangement examples of the pixels physically arranged in the pixel block 100 will be schematically described with reference to FIGS. 2A to 2D. FIG. 2A shows an example in which the pixel block 100 is constituted by sixteen pixels arranged in four rows and four columns. R, G, and B in FIG. 2A represent image capturing pixels 200 that perform image capturing. Each image capturing pixel 200 indicates one of an image capturing pixel Rᵢⱼ that mainly performs photoelectric conversion of red light, an image capturing pixel Gᵢⱼ that mainly performs photoelectric conversion of green light, and an image capturing pixel Bᵢⱼ for image capturing that mainly performs photoelectric conversion of blue light. Here, the subscripts i and j of R, G, and B indicate the row number i and the column number j which indicate the position in the pixel block 100. For example, B₂₄ represents the image capturing pixel that mainly performs photoelectric conversion of blue light, and indicates that it is located in the second row and fourth column in the pixel block 100 of four rows and four columns. For the image capturing pixels 200 that perform photoelectric conversion of respective colors, color separation of incident light can be performed by red, green, and blue on-chip color filters provided in the image capturing pixel 200.

The image capturing pixels 200 indicated by R, G, and B can output image capturing signals that can express gradation. To the contrary, the pixel indicated by E is an event detection pixel 201 that detects the change of light intensity. The event detection pixel 201 does not necessarily require color separation. A transparent color filter may be provided for the event detection pixel 201. Note that a transparent color filter may also be provided for the image capturing pixel 200. When a transparent color filter is provided for the image capturing pixel 200, color information is not obtained but the S/N ratio and resolution can be improved.

The applicable wavelength region of the color filter is not limited to the visible light region, and a filter for photoelectric conversion of ultraviolet light or infrared light may be used. It is also possible to arrange an on-chip microlens on each pixel. By arranging an on-chip microlens on the pixel, the S/N ratio can be improved. FIG. 2B shows an example of the pixel block in which the pixels are arranged in eight rows and eight columns. In this example, the pixel block includes sixteen event detection pixels E. FIG. 2C shows another example of the pixel block in which the pixels are arranged in eight rows and eight columns. In the example shown in FIG. 2C, four event detection pixels E, each being represented by "E", are arranged in the pixel block. FIG. 2D shows an example of the pixel block in which the pixels are arranged in four rows and two columns. The number of rows and the number of columns for arranging the pixels may be any numbers as long as they are natural numbers. As shown in FIG. 2D, the number of rows and the number of columns may not be the same in the pixel block.

The circuit configuration of the pixel arranged in the pixel block 100 will be schematically described with reference to a pixel portion 30 shown in FIG. 3. A photoelectric conversion element 300 can be an avalanche multiplication type diode. A reverse bias voltage equal to or higher than the breakdown voltage can be applied to the photoelectric conversion element 300. In this embodiment, the photoelectric conversion element 300 is set to operate in a Geiger mode. More specifically, a first power supply voltage Vg is applied from the first power supply line connected to the photoelectric conversion element 300 to the anode side of the photoelectric conversion element 300, and a second power supply voltage Vd is applied from the second power supply line connected to the photoelectric conversion element 300 to the cathode side of the photoelectric conversion element 300. The voltage difference between the first power supply voltage Vg and the second power supply voltage Vd is set to be equal to or higher than the breakdown voltage. For example, the first power supply voltage Vg may be -20 V, and the second power supply voltage Vd may be 3.3 V.

A reset unit 301 can reset the photoelectric conversion element 300 in accordance with the amount of charges generated in the photoelectric conversion element 300. The reset unit 301 may be a quenching element. The quenching element can be a PMOS transistor. A bias voltage V_{bias} applied to the control terminal of the quenching element forms a predetermined quenching resistance. When the quenching element is a PMOS transistor, the bias voltage V_{bias} applied to the gate terminal of the PMOS transistor is typically 0 V to 2 V.

The connection portion between the photoelectric conversion element 300 and the reset unit 301 is connected to the input of an inverter circuit 302. The photoelectric conversion element 300, the reset unit 301, and the inverter circuit 302 can constitute an event detection unit that detects light entering the photoelectric conversion element 300.

Next, the operations of the photoelectric conversion element 300 and the reset unit 301 will be described. Here, a case where the photoelectric conversion element 300 is a single photon avalanche diode (SPAD) will be described. When one photon enters the SPAD serving as the photoelectric conversion element 300, one electron-hole pair is generated. Thereafter, one electron (and one hole) is accelerated by an electric field, and a current is generated by a plurality of electrons (and holes). That is, the photoelectric conversion element 300 multiplies a photocurrent by avalanche multiplication.

The current obtained by the multiplied electrons flows from the node with the second power supply voltage Vd to the first power supply voltage Vg via the photoelectric conversion element 300 and the reset unit 301. This causes a potential drop of the cathode of the photoelectric conversion element, so that the operation region of the photoelectric conversion element 300 shifts out of the Geiger mode. As a result, the avalanche multiplication of the photoelectric conversion element 300 stops. Then, since the second power supply voltage Vd is supplied to the cathode of the photoelectric conversion element 300 via the reset unit 301, the voltage drop caused by the reset unit 301 is recovered. That is, the operation region of the photoelectric conversion element 300 returns to the Geiger mode.

Here, the reset unit 301 has a role of, after avalanche multiplication occurs, decreasing the cathode potential of the photoelectric conversion element 300 and then returning the operation region of the photoelectric conversion element 300 to the Geiger mode. With the operations described above, the reset unit 301 can reset the photoelectric conversion element 300 where avalanche multiplication has occurred.

In this manner, when the photoelectric conversion element 300 is the SPAD as described above, the reset unit 301 resets the photoelectric conversion element in accordance with the amount of multiplication of one generated charge. Therefore, the reset unit 301 can be controlled to perform the reset in accordance with whether a charge is generated by the incident photon or no charge is generated.

When an avalanche multiplication type diode is used as the photoelectric conversion element 300, the reset unit 301 resets the state of the photoelectric conversion element 300 in accordance with charges generated in the photoelectric conversion element 300 due to one photon. To the contrary, instead of using the avalanche multiplication type diode, a charge accumulation type photodiode may be used as the photoelectric conversion element 300. In this case, the reset unit 301 can be configured to reset the photoelectric conversion element in accordance with generation of a predetermined amount of charges. The predetermined amount is preferably set to an amount smaller than the saturated charge amount of the photodiode. While the amount of charges generated in the photoelectric conversion element 300 is smaller than the predetermined amount, the reset unit 301 does not perform the reset operation. On the other hand, if charges exceeding the predetermined amount are generated in the photoelectric conversion element 300, the reset unit 301 resets the photoelectric conversion element 300. By controlling in this manner, the photoelectric conversion element 300 can be reset in accordance with the generation amount of charges.

In addition to the method of resetting in accordance with the generation amount of charges, a method of resetting the photoelectric conversion element 300 when a predetermined time has elapsed may be used. In this method, regardless of whether charges are generated in the photoelectric conversion element 300, the reset unit 301 resets the photoelectric conversion element 300 when a predetermined time has elapsed. Hence, the effect of the reset method according to the elapsed time is different from that of the reset method according to the generation amount of charges. In this embodiment, control for resetting the photoelectric conversion element 300 in accordance with generation of a predetermined amount of charges and control for resetting the photoelectric conversion element 300 when a predetermined time has elapsed may be used together.

The cathode potential of the photoelectric conversion element 300 is input to the inverter circuit 302. The inverter circuit 302 can invert the input potential and output it. The inverter circuit 302 can shape the changes in potential, which occur due to the presence/absence of a photon entering the photoelectric conversion element 300, into a detection pulse. As described above, when a photon enters the photoelectric conversion element 300, the cathode potential of the photoelectric conversion element 300 drops. Since the cathode of the photoelectric conversion element 300 is connected to the inverter circuit 302, if the cathode potential is higher than the threshold of the inverter circuit 302, the inverter circuit 302 outputs a low level. On the other hand, if the cathode potential is lower than the threshold of the inverter circuit 302, the inverter circuit 302 outputs a high level. That is, the inverter circuit 302 can binarize the input potential and output it. As a result, the inverter circuit 302 can output a rectangular detection pulse in accordance with light entering the photoelectric conversion element 300.

A counter unit that counts the number of detection pulses is provided at the output of the inverter circuit 302. In FIG. 3, the counter unit is shown as a counter 303. The counter 303 counts the number of detection pulses output from the inverter circuit 302 only for a predetermined period, and outputs a cumulative count value to an output line. That is, the counter 303 can be a count unit that changes the count value when the detection pulse is received from the inverter circuit 302. Here, as described above, the inverter circuit 302 outputs the detection pulse in accordance with light entering the photoelectric conversion element 300. In other words, a signal generated by the photoelectric conversion element 300 is input to the counter 303 via the inverter circuit 302. The counter 303 performs a count operation of changing the count value in accordance with the signal from the photoelectric conversion element. As a result, the counter 303 can periodically count the output of the inverter circuit 302, so that the counter can count the number of times a photon enters the photoelectric conversion element 300 per unit time.

The counter 303 can be controlled to perform counting in accordance with whether light enters the photoelectric conversion element 300. This operation can change the count value in accordance with the signal from the photoelectric conversion element. When no charge is generated in the photoelectric conversion element 300, the counter 303 does not change the count value. The count value obtained by the counter 303 counting for a predetermined time can be used as an image capturing signal or an event detection signal.

If the photoelectric conversion element is an SPAD, the counter 303 can change the count value when a single photon enters the photoelectric conversion element. If the photoelectric conversion element is a charge accumulation type diode, the count value can be changed when a predetermined number of charges are generated in the photoelectric conversion element due to incident light. This operation is generally called photon counting. According to photon counting, the amount of multiplied charges can be significantly larger than the amount of signal charges generated by incident light, so that the S/N ratio of the output signal can be improved compared to the input signal. In addition, since A/D conversion is not required, signal arithmetic processing is facilitated.

The counter 303 can have N bits (N is an integer of 2 or more). The counter 303 can output a binary code. When the counter has three bits, the count value changes in accordance with the count, like "000", "001", "010", "011"....

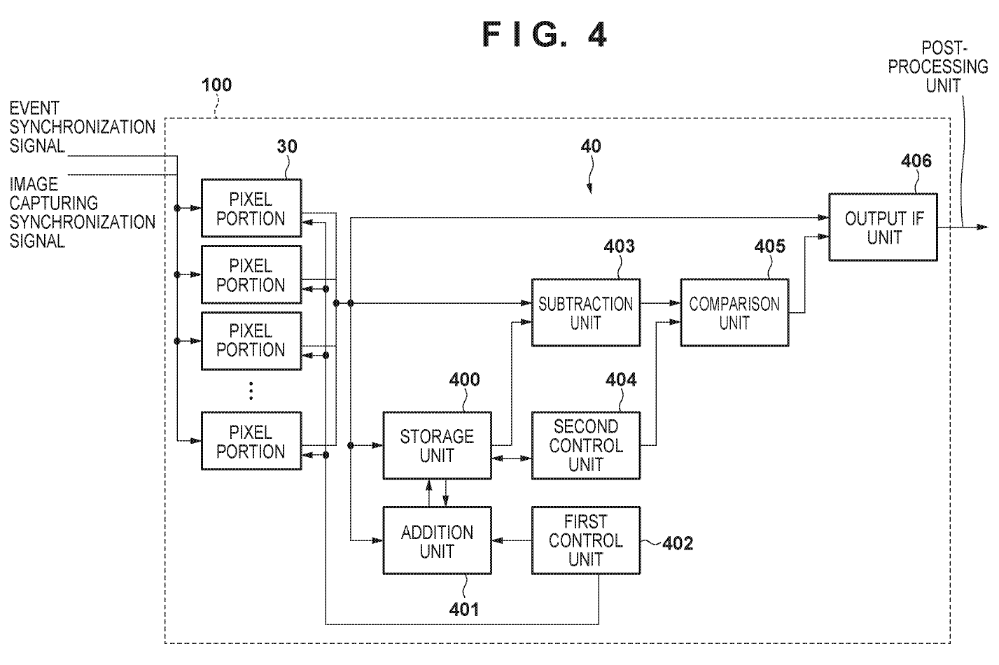

The data processing in the pixel block 100 according to this embodiment will be described with reference to FIG. 4. The pixel block 100 can include the pixel portions 30, a determination unit 40 that performs event detection, and an output interface (IF) unit 406. The determination unit 40 can include an addition unit 401, a storage unit 400, a subtraction unit 403, a first control unit 402, a second control unit 404, and a comparison unit 405.

The addition unit 401 can add the count values output from the counters 303 of the pixel portions 30, and output the sum. The storage unit 400 can store a reference value for event detection and the sum obtained by addition by the addition unit. The subtraction unit 403 subtracts a reference value stored in the storage unit 400 from the output of the counter 303 of the event detection pixel 201. The subtraction unit 403 can also subtract the reference value from the sum stored in the storage unit 400. The reference value may be, for example, the count value of the counter 303 of the event detection pixel 201 at the time when a change in event was detected immediately before the current event detection.

The first control unit 402 can control the addition unit 401 and the pixel portions 30 to stop the addition and control data readout from the pixel portions 30. The second control unit 404 can store and change a threshold for event detection. The comparison unit 405 can compare the output from the subtraction unit 403 with the threshold from the second control unit 404 to detect an event, and output an event detection signal. The output IF unit 406 can output the image capturing signal from the pixel portion 30 and the event detection signal from the comparison unit 405 to the outside of the pixel block 100. The output of the image capturing signal can be controlled in accordance with the event detection signal.

Next, an event detection operation according to this embodiment will be described with reference to FIG. 4. There are two modes for event detection. The first mode is a mode in which event detection is performed without adding the count values from the event detection pixels 201. The second mode is a mode in which event detection is performed by adding the count values from the event detection pixels 210. The processing in each mode is performed in the pixel block 100.

The first mode will be described. The event detection pixel 201 is controlled by an event synchronization signal. The counter 303 of the event detection pixel 201 performs counting during the period of the event synchronization signal, and the count result is read out under the control of the event synchronization signal. The output read out from the counter 303 is input to the subtraction unit 403. The subtraction unit 403 calculates the difference between the reference value stored in the storage unit 400 and the output from the counter 303 of the event detection pixel 201. The difference data corresponding to the difference is input to the comparison unit 405, and compared with the threshold output from the second control unit 404. The comparison result is output from the comparison unit 405.

The count value, which was output from the counter 303 of the event detection pixel 201 at the time when an event was detected immediately before the current detection, can be used as the reference value. In this case, each time an event is detected, the reference value can be updated with the count value of the event detection pixel 201 corresponding to the newly detected event. As described above, the reference value can be updated after the subtraction unit 403 performs calculation.

Note that the image capturing pixel 200 among the pixel portions 30 is controlled by an image capturing synchronization signal, and the output from the counter 303 of the image capturing pixel 200 is input to the output IF unit 406. The count value from the counter 303 of the image capturing pixel 200 can be used as an image capturing signal. The image capturing synchronization signal is a signal used to read out a signal from the image capturing pixel 200, and only required to have a rate that can achieve the common frame rate of moving image, such as 60 FPS or 120 FPS.

The event synchronization signal is a signal for reading out the count value for event detection from the event detection pixel 201. The event synchronization signal can be a signal corresponding to the event detection cycle. The event detection frequency is preferably set higher than the frame rate. To achieve this, the event synchronization signal may have a higher rate than the image capturing synchronization signal, and may be at 1,000 FPS. In this case, the first unit time during which the counter 303 of the event detection pixel 201 counts the detection pulses may be set shorter than the second unit time during which the counter 303 of the image capturing pixel 200 counts the detection pulses. In this case, the counter 303 of the image capturing pixel 200 and the counter 303 of the event detection pixel 201 may have the same bit width. Alternatively, assuming that the counter 303 of the image capturing pixel is the first counter and the counter 303 of the event detection pixel 201 is the second counter, the second counter may have a shorter bit width available for counting than the first counter.

The second control unit 404 may store a plurality of thresholds. Normally, two thresholds of a positive threshold and a negative threshold are stored to determine the direction of the brightness change corresponding to the event change. For example, if the change is larger than the positive threshold, it can be detected that the object has changed brighter. If the change is smaller than the negative threshold, it can be detected that the object has changed darker. The output of the comparison unit 405 is output to the post-processing unit 12 via the output IF unit 406. In addition to two positive and negative thresholds, a plurality of thresholds may be set. By changing the threshold, the event detection sensitivity can be set in accordance with the event detection target.

When the comparison unit 405 detects a brightness change exceeding the threshold, it is determined that an event has occurred, and the comparison unit 405 can output an event detection signal. The output IF unit 406 can receive the event detection signal, and output the output of the image capturing pixel 200 from the pixel block 100. In addition, the second control unit 404 can update the reference value stored in the storage unit 400. The update is performed by, for example, replacing the previous reference value with the value of the event detection signal at the time when the event is detected. Alternatively, the reference value can be updated using another method. For example, each time the event detection operation is performed under the control of the event synchronization signal, the previous reference value may be replaced and updated with the count value output from the counter 303 of the event detection pixel 201 according to the current event detection.

Next, the second mode for performing event detection by adding the count values from the event detection pixels 201 will be described. The first control unit 402 controls the addition unit 401 to add the outputs from the counters 303 of the pixels. More specifically, in the example shown in FIG. 2A, there are four event detection pixels 201, so that the count values respectively output from the four event detection pixels 201 are added. The addition may be performed not only for the event detection pixels 201 but also the image capturing pixels 200. The result of addition can be stored in the storage unit 400. The addition concerning the image capturing pixels 200 can be performed for each color with each of the colors of the image capturing pixels R_{IJ}, G_{IJ}, and B_{IJ} shown in FIG. 2A as a unit. For the event detection pixel E_{IJ}, the addition can be performed for the event detection pixels arranged in the pixel block 100. The addition is performed by the addition unit that adds the outputs from the counters of the respective pixels. Letting X_{ADD} be the result of addition of the pixels arranged with the color filters of the same color, and Yᵢⱼ be the result output from the counter of the pixel in ith row and jth column, the addition is performed as follows. In the arrangement shown in FIG. 2A, the result of addition of the pixels arranged with red filters is R_{ADD} = R₁₁ + R₁₃ + R₃₁ + R₃₃. Similarly, the result of addition of the pixels arranged with green filters is G_{ADD} = G₁₂ + G₁₄ + G₃₂ + G₃₄, and the result of addition of the pixels arranged with blue filters is B_{ADD} = B₂₂ + B₂₄ + B₄₂ + B₄₄. Similarly, the result of addition of the event detection pixels is E_{ADD} = E₂₁ + E₂₃ + E₄₁ + E₄₃.

When signals from four event detection pixels are added, the data width increases by up to two bits. Therefore, if necessary, an average may be calculated by shifting the result of addition by two bits to the right and dividing it by four. With this, a case where the signals from the event detection pixels are added and a case where the signals from the event detection pixels are not added can be made common. By adding multiple pixels, the S/N ratio can be improved. For the image capturing pixels 200R_{IJ}, G_{IJ}, and B_{IJ}, the roughness and noise in the image capturing signal can be reduced by the addition. For the event detection pixels E_{IJ}, the event detection error can be reduced. By excluding the count value from the defective pixel from the addition, the effect of the addition can be increased.

Next, the conditions for performing the addition by the first control unit 402 will be described. In the following cases, it is advantageous to perform addition. The first condition is a case where the object is under low illuminance. By performing the addition, the S/N ratio improves. For the image capturing pixels, noise can be reduced. For the event detection pixels, the event detection error can be reduced. The second condition is a case where the photoelectric conversion element is at high temperature. By performing the addition, the operations performed by the circuits driven in the subtraction unit 403, the comparison unit 405, and the like are decreased. Thus, heat generation caused by the operations can be suppressed. In addition to the effect similar to that in the first condition, when the photoelectric conversion element is an SPAD, the dark count rate (DCR) can be reduced in the second condition.

The third condition is a case where the event occurrence frequency is low. While reducing the detection error by performing the addition, an event-driven operation is performed, which is an operation performed only when an event occurs. This can achieve low power consumption. The fourth condition is a case where the event occurrence frequency is high. By performing the addition, the circuits to be driven are reduced. This can achieve power reduction. Alternatively, the frame rate may be increased to improve the object tracking ability. The fifth condition is a case where the contrast of incident light from the object is low. By performing the addition, a problem of blurred edges in high contrast portions can be decreased. The sixth condition is a case where the power supply environment of the photoelectric conversion apparatus changes. For example, when the battery is low or in a situation where the external power supply is lost, the circuits to be driven are reduced by performing the addition. This can extend the operation time.

The control of the addition unit 401 may be performed collectively for all the pixel blocks 100 arranged in the photoelectric conversion apparatus, or may be performed for each pixel block 100. As for the first to fifth conditions, the first control unit 402 in the pixel block 100 may have a determination function, or may be controlled by the pixel control unit 11 outside the pixel block. The pixel control unit 11 may also have a function of excluding the defective pixel from the targets of addition.

Next, effective use of the memory capacity of the storage unit 400 will be described. In a case where one pixel block is constituted by 4 × 4 pixels as shown in FIG. 2A, in the first mode where the addition is not performed, the memory for at least four pixels is required for storing the reference values for event detection with respect to the four event detection pixels 201. This is because, since the reference value is updated when an event is detected, the reference value is required for each of the different event detection pixels.

On the other hand, in the second mode where the addition is performed for the image capturing pixels 200 and the event detection pixels 201, the memory for one pixel is required for storing the reference value for event detection with respect to the event detection pixels after the addition. In addition, the memory for four pixels is required for storing the results of the addition of the image capturing pixels 200 indicated by R, G, and B and the event detection pixels 201 indicated by E. Hence, the memory for at least five pixels in total is required. In the pixel arrangement shown in FIG. 2A, the first mode requires the memory capacity for four pixels, and the second mode requires the memory capacity for five pixels. Since the values of the required capacities are close, it can be said that utilization efficiency of the memory is excellent.

In a case where one pixel block is constituted by 8 × 8 pixels as shown in FIG. 2B, in the second mode, the memory for four pixels is required for the image capturing pixels 200 of respective colors and the event detection pixels 201, as in the example of 4 × 4 pixels. In addition, the memory for one pixel is required for storing the reference value with respect to the event detection pixels 201. Hence, the memory for five pixels in total is required.

In the example shown in FIG. 2B, there are sixteen event detection pixels 201. In the first mode, the memory for sixteen pixels is required for storing the reference values with respect to sixteen event detection pixels 201. Accordingly, the amount of unused memory is larger in the first mode than in the second mode, so that the utilization efficiency of the memory decreases. Considering these, in a case where the pixel block is constituted by 8 × 8 pixels, from the viewpoint of the memory utilization efficiency, it is preferable to arrange four event detection pixels in one pixel block as shown in FIG. 2C, and prepare the memory for five pixels.

In accordance with the cycle of event detection, the length of data from the event detection pixel 201 can be set shorter than the length of data from the image capturing pixel 200. Therefore, by setting the bit width of the storage unit for holding data from the event detection pixel 201 smaller than the bit width of the storage unit for holding data from the image capturing pixel 200, the memory utilization efficiency can further be improved.

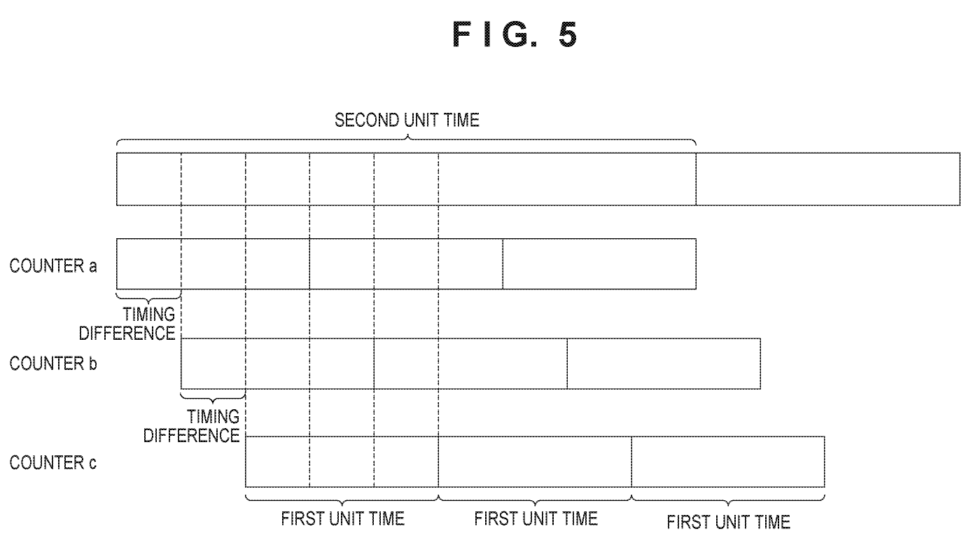

Next, the usage of the remaining memory in the second mode will be described with reference to FIG. 5. In a case where one pixel block is constituted by 4 × 2 pixels as shown in FIG. 2D, the second mode requires the memory for five pixels as in FIG. 2B, but the first mode requires only the memory for two pixels for storing the thresholds with respect to two event detection pixels 201 indicated by E. Hence, the memory for three pixels (five pixels - two pixels) remains unused. By utilizing the remaining memory, for example, the count value of the event detection signals is written in the remaining memory at a cycle three times that of the event synchronization signal, and event detection is performed. This can increase the time resolution of event detection.

An example of utilizing the remaining memory for three pixels will be described below. A counter unit that includes a plurality of counters configured to count the detection pulses per the first unit time at different timings is provided in one event detection pixel 201. To perform counting at three different timings, three counters of a counter a, a counter b, and a counter c are provided. The image capturing pixel 200 is provided with a counter unit that counts detection pulses per the second unit time. The second unit time is preferably a time corresponding to the cycle of the image capturing synchronization signal. The count value counted by the counter 303 in the second unit time can be used as an image capturing signal.

In this example, the first unit time is 1/3 the second unit time. The first unit time corresponds to the cycle of the event synchronization signal. The counter a, the counter b, and the counter c count detection pulses over the first unit time at different timings. If an event is detected in accordance with the count value of one of the counter a, the counter b, and the counter c, the comparison unit 405 outputs an event detection signal. When the event detection signal is input, the output IF unit 406 outputs the image capturing signal at the timing corresponding to the detected event from the pixel block 100. By utilizing the remaining memory in the second mode and performing event detection at a cycle shorter than the image capturing cycle and at different timings, the time resolution of event detection can be improved.

Also in the case where the counter unit including the plurality of counters is arranged in one event detection pixel 201, for the multiple event detection pixels 201 arranged in the pixel block 100, the counters of the respective counter units count detection pulses at the same timing. In the second mode, the values counted at the same timing may be added.

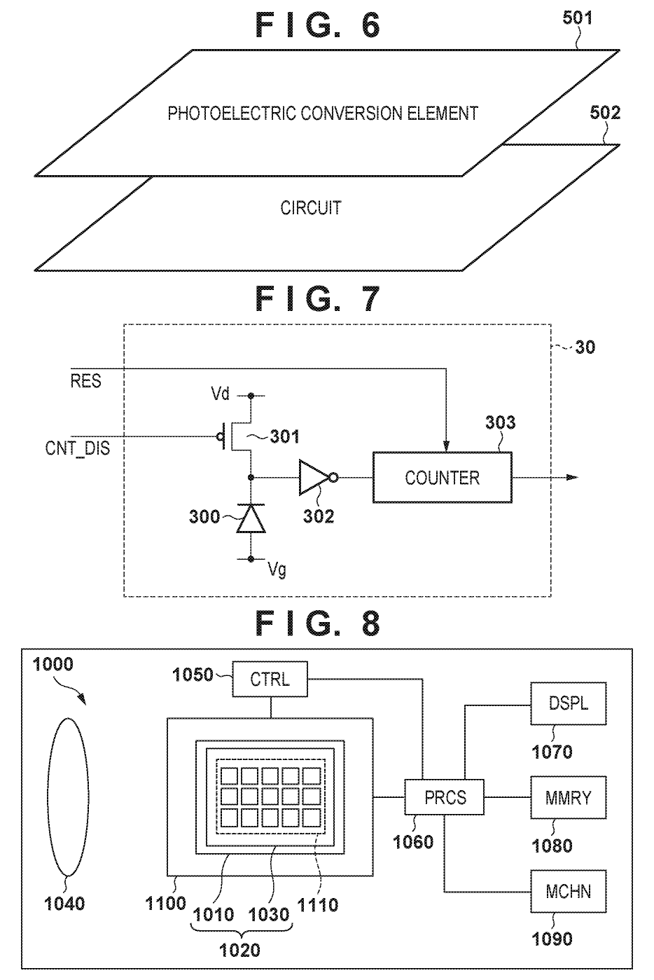

Next, the configuration of the photoelectric conversion apparatus according to this embodiment will be described with reference to FIG. 6. The photoelectric conversion apparatus may be formed by stacking a plurality of substrates. In this case, a substrate 501 including photoelectric conversion elements and a substrate 502 including other circuit portions may be separated, and the substrate 501 and the substrate 502 may be stacked. By arranging the photoelectric conversion elements in the substrate 501 while arranging circuits common to the counters, the pixels, and the whole in the other substrate 502, it is possible to increase the light receiving area of the photoelectric conversion element in a planar view while achieving faster circuit operation. The number of stacked substrates is not limited to two, and three or more substrates may be stacked. The functions assigned to the respective substrates are not limited to the configuration of this embodiment.

### CONTROL OF PHOTOELECTRIC CONVERSION ELEMENT

Referring mainly to FIG. 7, an example of control for the operation of the photoelectric conversion element 300 in a case where the photoelectric conversion element 300 is formed by an avalanche photodiode will be described. In this example, a PMOS transistor is shown as the quenching element of the reset unit 301. The first control unit 402 can supply one of the predetermined fixed bias potential V_{bias} and a count disable signal CNT_DIS to the control terminal of the quenching element. The count disable signal CNT_DIS is a signal with a potential that can cut off the quenching element of the reset unit 301. When the first control unit 402 supplies the CNT_DIS signal to the quenching element, the quenching element is cut off and controlled not to supply a current from the second power supply voltage Vd to the avalanche photodiode. This control makes it possible to disable the operation of the photoelectric conversion element, thereby thinning out the pixels to read out signals.

By thinning out the pixels to read out signals and not reading or processing signals from the thinned out pixels, power consumption can be reduced. The control for reducing power consumption by thinning out pixels is effective when the temperature of the photoelectric conversion element becomes high, when it is desired to reduce power consumption in a case where the event occurrence frequency is low or high, when the battery is low, and when the external power supply is lost. Furthermore, by prioritizing defective pixels as targets for thinning, in addition to the above-described effect, the event detection accuracy can be improved.

### Application of Photoelectric Conversion Apparatus to Equipment

The following is a description of equipment 1000 that includes a semiconductor apparatus 1100 including a package 1020 on which a semiconductor chip 1110 including a semiconductor integrated circuit is mounted, as shown in FIG. 8. The semiconductor chip 1110 is accommodated in the package 1020 and mounted on the equipment 1000. In the arrangement shown in FIG. 8, the semiconductor chip 1110 includes the photoelectric conversion apparatus according to the embodiment described above. The semiconductor apparatus 1100 can include the package 1020 including a base 1010 on which the semiconductor chip 1110 is fixed and a light transmissive member 1030 such as glass that faces the semiconductor chip 1110. The package 1020 can be provided with joining members such as wires and bumps that connect inner leads provided on the base 1010 to terminals such as pad electrodes provided on the semiconductor chip 1110.

The equipment 1000 can include at least one of an optical apparatus 1040, a control apparatus 1050, a processing apparatus 1060, a display apparatus 1070, a storage apparatus 1080, and a mechanical apparatus 1090. The optical apparatus 1040 is implemented by, for example, a lens, a shutter, and a mirror. The control apparatus 1050 controls the semiconductor chip 1110. The control apparatus 1050 is, for example, a semiconductor device such as an ASIC.

The processing apparatus 1060 processes a signal output from the photoelectric conversion apparatus included in the semiconductor chip 1110. The processing apparatus 1060 is a semiconductor device such as a CPU or an ASIC for forming an Analog Front End (AFE) or a Digital Front End (DFE). For example, an image may be generated based on an image capturing signal at the time of detecting an event. The display apparatus 1070 is an EL display device or a liquid crystal display device that displays an information image obtained by the semiconductor chip 1110. The storage apparatus 1080 is a magnetic device or a semiconductor device that stores the information image obtained by the semiconductor chip 1110. The storage apparatus 1080 is a volatile memory such as an SRAM or a DRAM, or a nonvolatile memory such as a flash memory or a hard disk drive.

The mechanical apparatus 1090 includes a moving or propulsion unit such as a motor or an engine. In the equipment 1000, the signal output from the semiconductor chip 1110 is displayed on the display apparatus 1070 or transmitted to an external apparatus by a communication apparatus (not shown) included in the equipment 1000. Hence, the equipment 1000 may further include the storage apparatus 1080 and the processing apparatus 1060 in addition to the memory circuits and arithmetic circuits included in the semiconductor chip 1110. The mechanical apparatus 1090 may be controlled based on the signal output from the semiconductor chip 1110.

The equipment 1000 is suitable for electronic equipment such as an information terminal which has a shooting function, for example, a smartphone or a wearable terminal, or a camera, for example, an interchangeable lens camera, a compact camera, a video camera, or a monitoring camera. The mechanical apparatus 1090 in the camera can drive the components of the optical apparatus 1040 in order to perform zooming, an in-focus operation, and a shutter operation. Alternatively, the mechanical apparatus 1090 in the camera can move the optical apparatus 1040 in order to perform an anti-vibration operation.

Furthermore, the equipment 1000 can be transportation equipment such as a vehicle or a ship, or an aircraft. The mechanical apparatus 1090 in the transportation equipment can be used as a moving apparatus. The equipment 1000 as the transportation equipment is suitable for equipment that transports the semiconductor chip 1110 or equipment that uses a shooting function to assist and/or automate drive steering. The processing apparatus 1060 for assisting and/or automating drive steering can perform, based on the information obtained by the semiconductor chip 1110, processing for operation of the mechanical apparatus 1090 as a moving apparatus. Alternatively, the equipment 1000 may be medical equipment such as an endoscope, measurement equipment such as a distance measurement sensor, analysis equipment such as an electron microscope, office equipment such as a copy machine, or industrial equipment such as a robot.

According to the present disclosure, it is possible to provide a technique advantageous for performing event detection in accordance with a change in detection environment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A photoelectric conversion apparatus in which a plurality of pixel blocks are arranged, each pixel block including
a plurality of first pixels,
a plurality of event detection pixels,
a determination unit configured to perform event detection, and
an interface unit configured to output signals from the plurality of first pixels in accordance with the event detection,
wherein each of the plurality of event detection pixels includes a first event detection unit configured to output a signal in accordance with incident light, and a first counter unit configured to count signals output from the first event detection unit per a first unit time, and
the determination unit performs the event detection based on a sum of outputs from the first counter units of the plurality of event detection pixels.

2. The photoelectric conversion apparatus according to claim 1,
wherein each of the plurality of first pixels includes a second event detection unit configured to output a signal in accordance with incident light, and a second counter unit configured to count signals output from the second event detection unit per a second unit time.

3. The photoelectric conversion apparatus according to claim 2, wherein the first unit time is shorter than the second unit time.

4. The photoelectric conversion apparatus according to claim 2, wherein one of a red color filter, a blue color filter, and a green color filter is arranged in each of the plurality of first pixels.

5. The photoelectric conversion apparatus according to claim 4, wherein, in accordance with the event detection, outputs from the second counter units of pixels arranged with color filters of the same color among the first pixels are summed and output to the interface unit.

6. The photoelectric conversion apparatus according to claim 5, wherein the determination unit further includes a storage unit configured to store a sum of outputs from the first counter units of the plurality of event detection pixels, a sum of outputs from the second counter units of pixels arranged with color filters of the same color among the first pixels, and a reference value for the event detection.

7. The photoelectric conversion apparatus according to claim 1,
wherein the plurality of event detection pixels are arranged in four in the pixel block.

8. The photoelectric conversion apparatus according to claim 1,
wherein the first counter unit includes a plurality of counters, and the plurality of counters count signals from the first event detection unit at different timings.

9. The photoelectric conversion apparatus according to claim 1,
wherein an output from the first counter unit of a predetermined event detection pixel among the plurality of event detection pixels is excluded from targets of the summing.

10. The photoelectric conversion apparatus according to claim 1, further comprising a control unit, wherein the control unit is configured to control to stop the summing.

11. The photoelectric conversion apparatus according to claim 10,
wherein the control unit controls to stop the summing in accordance with at least one of a light incidence frequency, an illuminance of incident light, a temperature of the first event detection unit, a contrast of incident light, and a power supply status.

12. A photoelectric conversion apparatus in which a plurality of pixel blocks are arranged, each pixel block including
a plurality of first pixels,
a plurality of event detection pixels,
a determination unit configured to perform event detection, and
a control unit configured to control an operation of each of the plurality of event detection pixels,
wherein each of the plurality of event detection pixels includes an avalanche photodiode, and
the control unit can disable an operation of the avalanche photodiode.

13. The photoelectric conversion apparatus according to claim 12, wherein each of the plurality of event detection pixels includes the avalanche photodiode and a quenching element connected to the avalanche photodiode, and the control unit controls a bias voltage supplied to the quenching element.

14. Equipment comprising:
a photoelectric conversion apparatus defined in any one of claims claim 1; and
a processing apparatus configured to process an output signal from the photoelectric conversion apparatus.
